(19) United States
(12) Patent Application Publication
(10) Pub. No.: US 2025/0344265 A1
(43) Pub. Date: Nov. 6, 2025

(54) Apparatus and Method for Establishing a Direct Communication Connection to a Network Via an Access Point of a Different Network Type

(71) Applicant: LENOVO (SINGAPORE) PTE. LTD., SINGAPORE (SG)

(72) Inventors: Andreas Kunz, Ladenburg (DE); Sheeba Backia Mary Baskaran, Friedrichsdorf (DE)

(21) Appl. No.: 18/655,418

(22) Filed: May 6, 2024

(51) Int. Cl. H04W 76/14; H04W 12/033; H04W 12/06

(52) U.S. Cl. CPC H04W 76/14; H04W 12/033; H04W 12/06

(57) ABSTRACT

Various aspects of the present disclosure relate to establishing a direct communication connection to a network via an access point of a network of a different type. The establishment of the direct communication connection can include the performance of an authentication procedure with the network, via the access point of the network of the different type, wherein the authentication procedure includes sending a registration request message to the network via the access point of the network of the different type, which indicates support for non-integrated non-network access. A request response from the network can then be received, which includes an address of a network entity with which a user equipment (UE) can establish a direct communication connection within the network. The UE can then communicate with the network entity via the established direct communication connection using the received address.

### TECHNICAL FIELD

The present disclosure relates to wireless communications, and more specifically to an apparatus and method for establishing a direct communication connection to a network via an access point of a network of a different type.

### BACKGROUND

A wireless communications system may include one or multiple network communication devices, such as base stations, which may support wireless communications for one or multiple user communication devices, which may be otherwise known as user equipment (UE), user devices, or other suitable terminology. The wireless communications system may support wireless communications with the one or multiple user communication devices by utilizing resources, such as time resources (e.g., symbols, slots, subframes, frames, or the like) and/or frequency resources (e.g., subcarriers, carriers, or the like), of the wireless communication system. Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

In some implementations of the method and apparatuses, described herein, a direct communication connection to a network can be established via an access point of a network of a different type. The establishment of the direct communication connection can include the performance of an authentication procedure with the network, via the access point of the network of the different type, wherein the authentication procedure includes sending a registration request message to the network via the access point of the network of the different type, which indicates support for non-integrated non-network access. A request response from the network can then be received, which includes an address of a network entity with which a user equipment (UE) can establish a direct communication connection within the network. The UE can then communicate with the network entity via the established direct communication connection using the received address.

In some implementations of the method and apparatuses described herein, a direct communication connection to a user equipment (UE) can be established via an access point of a network of a different type. The establishment of the direct communication connection can include the performance of an authentication procedure with the UE, via the access point of the network of the different type, wherein the authentication procedure includes receiving a registration request message from the UE via the access point of the network of the different type, which indicates support for non-integrated non-network access. An encryption key can then be derived for use as part of the communications via the direct communication connection to the network in each of the UE and the network. An address of a selected network entity with which the UE establishes the direct communication connection within the network is selected. A message is sent to the selected network entity, which includes the encryption key. A request response is then sent to the UE, which includes the address of the selected network entity with which the UE establishes a direct communication connection within the network.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 illustrates an example of a wireless communications system in accordance with aspects of the present disclosure.

FIG. 2 illustrates an example of a signal flow diagram for establishing a direct communication connection to a network via an access point of a network of a different type in accordance with aspects of the present disclosure.

FIG. 3 illustrates an example of a signal flow diagram for establishing a direct communication connection to a network via an access point of a network of a different type in accordance with further aspects of the present disclosure.

FIG. 4 illustrates an example of a user equipment (UE) in accordance with aspects of the present disclosure.

FIG. 5 illustrates an example of a processor in accordance with aspects of the present disclosure.

FIG. 6 illustrates an example of a network equipment (NE) in accordance with aspects of the present disclosure.

FIG. 7 illustrates a flowchart of a method performed by a UE in accordance with aspects of the present disclosure.

FIG. 8 illustrates a flowchart of a method performed by a NE in accordance with aspects of the present disclosure.

### DETAILED DESCRIPTION

The 3rd Generation Partnership Project (3GPP) architecture group SA2 started a new study on multi-access traffic steering, switching and splitting support (MASSS) in the 5G system architecture Technical Report (TR) 23.700-54 where Multipath Quick User Datagram Protocol (UDP) Internet Connections (MPQUIC) is used as a multipath protocol between the UE and the User Plane Function (UPF). TR 23.700-54 introduces the concept of non-Integrated non-3GPP Access (NIN3A), a type of non-3GPP access network that provides direct IP connectivity between the UE and the UPF without any intermediate Network Function (NF), such as a Non-3GPP Interworking Function (N3IWF) and/or a Trusted Non-3GPP Gateway Function (TNGF). This access type should not compromise the security of the 5G network. The Internet Protocol (IP) connectivity is thought to carry the MPQUIC traffic directly to the UPF.

The 3GPP security group SA3 agreed in a few documents to be included in the technical report TR 33.754, that those documents discussed the possible direct communication between the UE and UPF and the requirement of authentication. For example, 3GPP S3-241577 describes the basic security features of this specific type of access:
Authentication: Ensuring the UE's identity is securely verified and authenticated before establishing a direct connection to the UPF; and
Privacy and Identity Protection: Protecting the UE's identity during the process of establishing connectivity.

This is formulated in the two security requirements:
The 5G System should support the ability to authenticate a UE accessing the network via Non-Integrated Non-3GPP Access (NIN3A); and
The authentication mechanism should not compromise the privacy of the UE.

The challenge involves how to authenticate the UE with the UPF for the non-Integrated non-3GPP Access (NIN3A) for MPQUIC traffic.

At least some of the noted concerns in the above study items have not been sufficiently addressed in the current 5G security specifications 3GPP TR 33.754 or 3GPP Technical Specification (TS) 33.501. In other words, There is no procedure on how the UE is getting authenticated before direct access to the UPF is established via a non-3GPP access network.

Aspects of the present disclosure are described in the context of a wireless communications system.

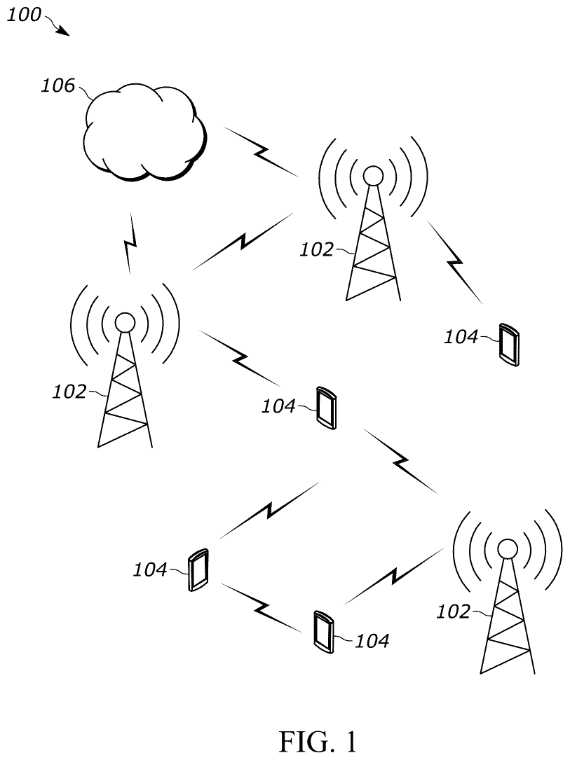

FIG. 1 illustrates an example of a wireless communications system 100 in accordance with aspects of the present disclosure. The wireless communications system 100 may include one or more NE 102, one or more UE 104, and a network 106. The wireless communications system 100 may support various radio access technologies. In some implementations, the wireless communications system 100 may be a fourth generation (4G) network, such as a long-term evolution (LTE) network or an LTE-Advanced (LTE-A) network. In some other implementations, the wireless communications system 100 may be a new radio (NR) network, such as a fifth generation (5G) network, a 5G-Advanced (5G-A) network, or a 5G ultrawideband (5G-UWB) network. In other implementations, the wireless communications system 100 may be one of, or a combination of, a 4G network, a 5G network, a Third Generation Partnership Project (3GPP)-based network, one or more of a future generation network (6G, etc.), and/or one or more of any other suitable radio access technology, wireless access technology, and/or wired access technology, including Institute of Electrical and Electronics Engineers (IEEE) 802.11 (Wi-Fi), IEEE 802.16 (WiMAX), and/or IEEE 802.20, a Wireless Local Area Network (WLAN), a satellite communication network, a high-altitude platform network, the Internet, and/or other communication networks. The wireless communications system 100 may support radio access technologies beyond 5G, for example, 6G. Additionally, the wireless communications system 100 may support various multiple access technologies, such as time division multiple access (TDMA), frequency division multiple access (FDMA), code division multiple access (CDMA), orthogonal frequency division multiple access (OFDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), an access point, a transmission-reception point (TRP), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or Machine-Type Communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the network 106, or with another NE 102, or both. For example, an NE 102 may interface with another NE 102 or the network 106 through one or more backhaul links (e.g., S1, N2, N2, or network interface). In some implementations, the NE 102 may communicate with each other directly. In some other implementations, the NE 102 may communicate with each other or indirectly (e.g., via the network 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or TRPs.

The network 106 may support user authentication, access authorization, tracking, connectivity, and other access, routing, or mobility functions. The network 106 may be an evolved packet core (EPC), or a 5GC, which may include a control plane entity that manages access and mobility (e.g., a Mobility Management Entity (MME), an Access and Mobility Management Function (AMF)) and a user plane entity that routes packets or interconnects to external networks (e.g., a Serving Gateway (S-GW), a Packet Data Network (PDN) Gateway (P-GW), or a User Plane Function (UPF)). In some implementations, the control plane entity may manage Non-Access Stratum (NAS) functions, such as mobility, authentication, and bearer management (e.g., data bearers, signal bearers, etc.) for the one or more UEs 104 served by the one or more NE 102 associated with the network 106.

The network 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a Protocol Data Unit (PDU) session, or the like) with the network 106 via an NE 102. The network 106 may route traffic (e.g., control information, data, and the like) between the UE 104 and the application server using the established session (e.g., the established PDU session). The PDU session may be an example of a logical connection between the UE 104 and the network 106 (e.g., one or more network functions of the network 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an Electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHz), FR2 (24.25 GHZ-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UE 104 may perform wireless communications over one or more of the operating frequency bands. In some implementations, FR1 may be used by the NEs 102 and the UEs 104, among other equipment or devices for cellular communications traffic (e.g., control information, data, etc.). For example, communication traffic can include user data, control information, and other communication traffic. The control information can be used for establishing and controlling communications that transmit and receive the user data, such as in packets, in physical shared channels, in data regions of subframes, and in other communications. In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

At least some embodiments of the present application can be directed to an authentication via an untrusted non-3GPP Access Point and further authentication within MPQUIC/Transport Layer Security (TLS) 1.3 with a new UPF key.

Such an embodiment can have one or more of the following features:
The UE indicates the MPQUIC/NIN3A feature support when accessing the non-3GPP network;
The Authentication and Non-Access Stratum (NAS) Security Mode Command (SMC) procedures are executed without any changes;
The Access and mobility Management Function (AMF), based on the indication from the UE, derives a UPF key K_{UPF}, and provides it to the selected UPF potentially via the Session Management Function (SMF). The AMF provides the UPF address to the UE in the NAS Registration Accept message; and
The UE derives the UPF key in the similar way as the AMF, e.g. like any access network keys as described in Annex “A.9 KgNB, KWAGF, KTNGF, KTWIF and KN3IWF derivation function” of 3GPP TS 33.501. In order to distinguish the UPF key K_{UPF} from the K_{N3IWF} or K_{TNGF}/K_{TWIF}, which are used in parallel in this specific case, the Uplink NAS COUNT can be set to 0 for K_{UPF} key generation.

In the following the direct MPQUIC session setup is described with the example of an untrusted non-3GPP access as described in section “7.2.1 Authentication for Untrusted non-3GPP Access” of 3GPP TS 33.501.

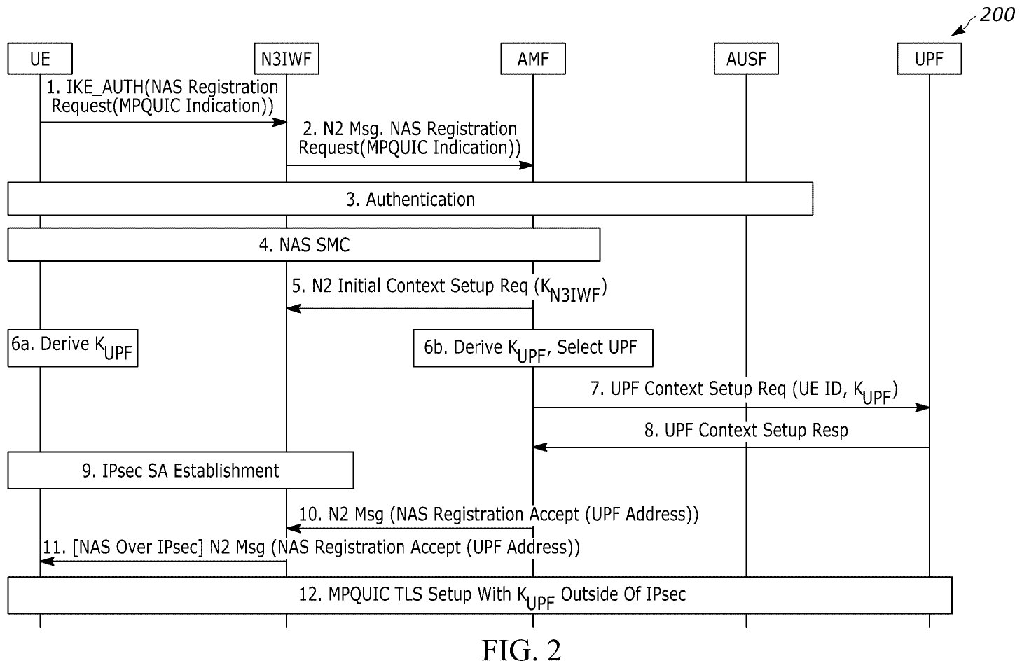

FIG. 2 illustrates an example of a signal flow diagram 200 for establishing a direct communication connection to a network via an access point of a network of a different type in accordance with aspects of the present disclosure. More specifically, in connection with the illustrated embodiment, FIG. 2 includes a direct MPQUIC setup with a UPF key via an untrusted non-3GPP access.

Further, the steps in the flow diagram illustrated in FIG. 2 can correspond to steps 1-5 of clause “7.2.1 Authentication for Untrusted non-3GPP Access”, 3GPP TS 33.501 and can be summarized, as follows:
The UE connects to an untrusted non-3GPP access network with procedures outside the scope of 3GPP and proceed with the establishment of an IPsec Security Association (SA) with the selected N3IWF by initiating an Internet Key Exchange (IKE) initial exchange;
The UE can initiate an IKE_AUTH exchange by sending an IKE_AUTH request message;
The N3IWF responds with an IKE_AUTH response message which includes the N3IWF identity, the AUTH payload to protect the previous message it sent to the UE (in the IKE_SA_INIT exchange); and
The UE can validate the N3IWF certificate.

As part of the illustrated embodiment, the steps for establishing a direct communication connection to a network via an access point of a network of a different type can include:
1. The UE sending an IKE_AUTH request which includes an Extensible Authentication Protocol (EAP)-Response/5G-NAS packet that contains a Registration Request message containing UE security capabilities and the Subscription Concealed Identifier (SUCI) and an indication that the UE supports MPQUIC/non-Integrated non-3GPP Access (NIN3A);
2. The N3IWF selecting an AMF and forwarding a Registration Request with the indication that the UE supports MPQUIC/NIN3A to the AMF;
3. The AMF initiating the authentication procedure between AUSF and the UE following the normal procedures;
4. The AMF performing the NAS SMC operation following the normal procedures;
5. The AMF upon reception of the NAS SMC Complete from the UE or upon success of integrity protection verification, initiating the NGAP procedure to set up the AN context. The AMF further computing the N3IWF key, K_{N3IWF}, using the uplink NAS COUNT associated with NAS connection identifier “0x02” for the establishment of the IPsec SA between the UE and the N3IWF and including it in the N2 Initial Context Setup Request sent to the N3IWF;
6. The UE and the AMF deriving the UPF key similar to the N3IWF key, i.e. NAS connection identifier “0x02” and Uplink NAS COUNT can be set to 0 to avoid that the K_{UPF} is the same key as the K_{N3IWF}. To avoid the situation that the uplink NAS COUNT is 0 also for the K_{N3IWF} derivation, additional parameters may be considered, or, a new access type “UPF” with the value “0x03” may be used to the K_{UPF} generation. The AMF further selecting the UPF;
7. The AMF sending a UPF Context Setup message to the UPF, containing the UE Identity (Subscription Permanent Identifier (SUPI), Generic Public Subscription Identifier (GPSI), etc.) and the UPF key K_{UPF}. The message may be sent via the SMF (not shown);
8. The UPF storing the key K_{UPF} and the UE ID and providing an acknowledgment message to the AMF. The message may be sent via the an SMF (not shown);
9. The IPsec SA can be established between the UE and N3IWF by using the N3IWF key K_{N3IWF};
10. The AMF sending the NAS Registration Accept message including the UPF address to the N3IWF;
11. The N3IWF forwarding the NAS Registration Accept message including the UPF address to the UE over the established IPsec SA. All further NAS messages between the UE and the N3IWF can be sent over the established IPsec SA; and
12. The UE setting up the MPQUIC session towards the UPF outside the IPSec SAs between the UE and the N3IWF. The UE and the UPF can use the K_{UPF} for mutual authentication and the TLS session setup, i.e. as input for the algorithms for confidentiality and integrity protection.

At least further embodiments of the present application can be directed to an authentication via a trusted non-3GPP Access Point and further authentication within MPQUIC/TLS1.3 with a new UPF key. The procedure can be also applied in a similar way to the trusted Non-3GPP Access procedure as specified in 3GPP TS 33.501, clause “7A.2.1 Authentication for trusted non-3GPP access”.

Such an embodiment can have one or more of the following features:
The UE indicates the MPQUIC/NIN3A feature support when accessing the non-3GPP network;
The Authentication and Non-Access Stratum (NAS) Security Mode Command (SMC) procedures are executed without any changes;
The Access and mobility Management Function (AMF), based on the indication from the UE, derives a UPF key K_{UPF}, and provides it to the selected UPF potentially via the Session Management Function (SMF). The AMF provides the UPF address to the UE in the NAS Registration Accept message; and
The UE derives the UPF key in the similar way as the AMF, e.g. like any access network keys as described in Annex “A.9 KgNB, KWAGF, KTNGF, KTWIF and KN3IWF derivation function” of 3GPP TS 33.501. In order to distinguish the UPF key K_{UPF} from the K_{N3IWF} or K_{TNGF}/K_{TWIF}, which are used in parallel in this specific case, the Uplink NAS COUNT can be set to 0 for K_{UPF} key generation.

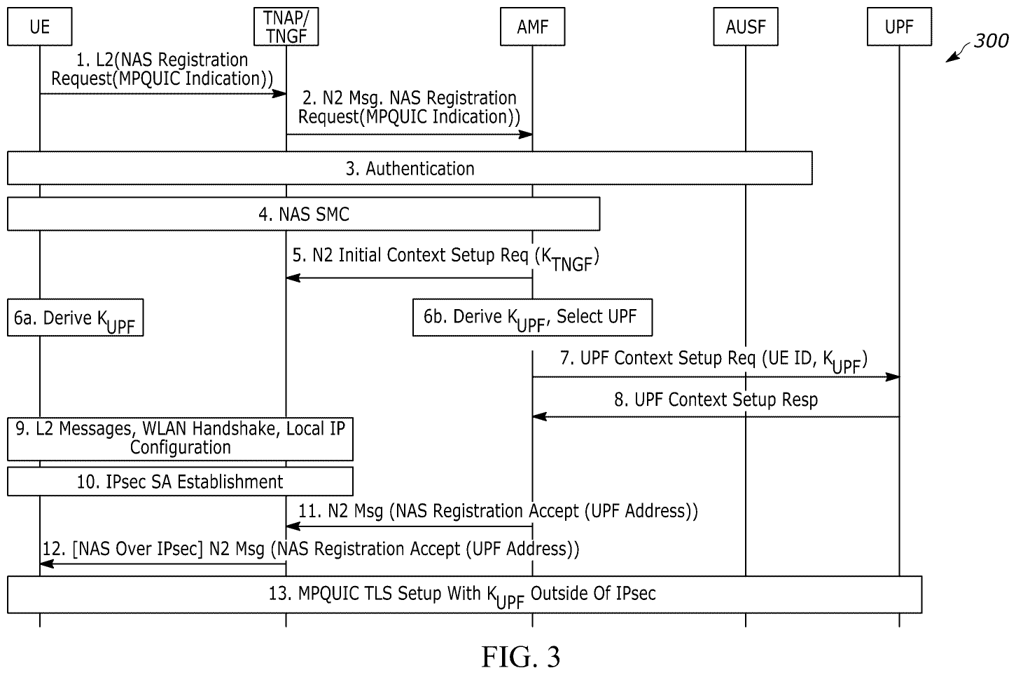

FIG. 3 illustrates an example of a signal flow diagram 300 for establishing a direct communication connection to a network via an access point of a network of a different type in accordance with further aspects of the present disclosure. More specifically, in connection with the illustrated embodiment, FIG. 3 includes a direct MPQUIC setup with a UPF key via a trusted non-3GPP access.

Further, the steps in the flow diagram illustrated in FIG. 2 can correspond to steps 1-5 of clause “7A.2.1 Authentication for trusted non-3GPP access” in TS 33.501 and summarized as follows:
The UE can select a Public Lan Mobile Network (PLMN) and a Trusted Non-3GPP Access Network (TNAN) for connecting to this PLMN by using the Trusted Non-3GPP Access Network selection procedure;
A layer-2 connection can be established between the UE and the Trusted Non-3GPP Access Point (TNAP);
An Extensible Authentication Protocol (EAP) authentication procedure can be initiated;
An EAP messages can be encapsulated into layer-2 packets;
The UE can provide a Network Access Identifier (NAI) that triggers the TNAP to send an Authentication, Authorization and Accounting (AAA) request to a TNGF; and
Between the TNAP and TNGF the EAP packets can be encapsulated into AAA messages.

As part of the illustrated embodiment, the steps for establishing a direct communication connection to a network via an access point of a network of a different type can include:
1. The UE sending an IKE_AUTH request which includes an Extensible Authentication Protocol (EAP)-Response/5G-NAS packet that contains a Registration Request message containing UE security capabilities and the Subscription Concealed Identifier (SUCI) and an indication that the UE supports MPQUIC/non-Integrated non-3GPP Access (NIN3A);
2. The TNGF selecting an AMF and forwarding a Registration Request with the indication that the UE supports MPQUIC/NIN3A to the AMF;
3. The AMF initiating the authentication procedure between AUSF and the UE following the normal procedures;
4. The AMF performing the NAS SMC operation following the normal procedures;
5. The AMF upon reception of the NAS SMC Complete from the UE or upon success of integrity protection verification, initiating the NGAP procedure to set up the AN context. The AMF further computing the TNGF key, K_{TNGF}, using the uplink NAS COUNT associated with NAS connection identifier “0x02” for the establishment of the IPsec SA between the UE and the TNGF and including it in the N2 Initial Context Setup Request sent to the TNGF;
6. The UE and the AMF deriving the UPF key similar to the TNGF key, i.e. NAS connection identifier “0x02” and Uplink NAS COUNT can be set to 0 to avoid that the K_{UPF} is the same key as the K_{TNGF}. To avoid the situation that the uplink NAS COUNT is 0 also for the K_{TNGF} derivation, additional parameters may be considered, or, a new access type “UPF” with the value “0x03” may be used to the K_{UPF} generation. The AMF further selecting the UPF;
7. The AMF sending a UPF Context Setup message to the UPF, containing the UE Identity (Subscription Permanent Identifier (SUPI), Generic Public Subscription Identifier (GPSI), etc.) and the UPF key K_{UPF}. The message may be sent via the SMF (not shown);
8. The UPF storing the key K_{UPF} and the UE ID and providing an acknowledgment message to the AMF. The message may be sent via the an SMF (not shown);
9. The common TNAP key being used by the UE and TNAP to derive security keys according to the applied non-3GPP technology and establishing a security association to protect all subsequent traffic. In case of IEEE 802.11, the K_{TNAP} being the Pairwise Master Key (PMK) and a 4-way handshake being executed which establishes a security context between the WLAN AP and the UE that is used to protect unicast and multicast traffic over the air. All messages between UE and TNAP can be encrypted and integrity protected from this step onwards. The UE receiving IP configuration from the TNAN, e.g. with DHCP.
10. The IPsec SA can be established between the UE and TNGF by using the key K_{TIPSec};
11. The AMF sending the NAS Registration Accept message including the UPF address to the TNGF;
12. The TNGF forwarding the NAS Registration Accept message including the UPF address to the UE over the established IPsec SA. All further NAS messages between the UE and the TNGF can be sent over the established IPsec SA; and
13. The UE initiating a PDU session establishment and setting up the MPQUIC session towards the UPF outside the IPSec SAs between UE and the TNGF. The UE and the UPF using the K_{UPF} for mutual authentication and the TLS session setup, i.e. as input for the algorithms for confidentiality and integrity protection.

Correspondingly, in the present application, apparatus and methods are described, which support the concept of non-Integrated non-3GPP Access (NIN3A), a type of non-3GPP access network that provides direct IP connectivity between the UE and the UPF without any intermediate NF being introduced. This addresses any concerns as to how to authenticate the UE with the UPF for the non-Integrated non-3GPP Access (NIN3A) for MPQUIC traffic.

The UE can indicate the MPQUIC/NIN3A feature support when accessing the non-3GPP network. The Authentication and NAS SMC procedures can be executed without any changes. The AMF, based on the indication from the UE, can derive an UPF key K_{UPF}, and provides it to the selected UPF potentially via SMF. The AMF can provide the UPF address to the UE in the NAS Registration Accept message. The UE can derive the UPF key in the similar way as the AMF. In order to distinguish the UPF key K_{UPF} from the K_{N3IWF} or K_{TNGF}/K_{TWIF}, which are used in parallel in this specific case, the Uplink NAS COUNT can be set to 0 for K_{UPF} key generation.

This can support establishing a direct communication connection using an Untrusted Non-3GPP Access, where the UE can indicate MPCUIC/NIN3A support, and the AMF and UE can derive a UPF key which the AMF can provide to the UPF. The AMF can then provide the UPF address to the UE, and the MPQUIC connection can be established with the UPF key for mutual authentication and protection of the TLS connection.

Further this can support establishing a direct communication connection using a Trusted Non-3GPP Access, where the UE can indicate MPCUIC/NIN3A support, and the AMF and UE can derive a UPF key which the AMF can provide to the UPF. The AMF can tehn provide the UPF address to the UE, and the MPQUIC connection can be established with the UPF key for mutual authentication and protection of the TLS connection.

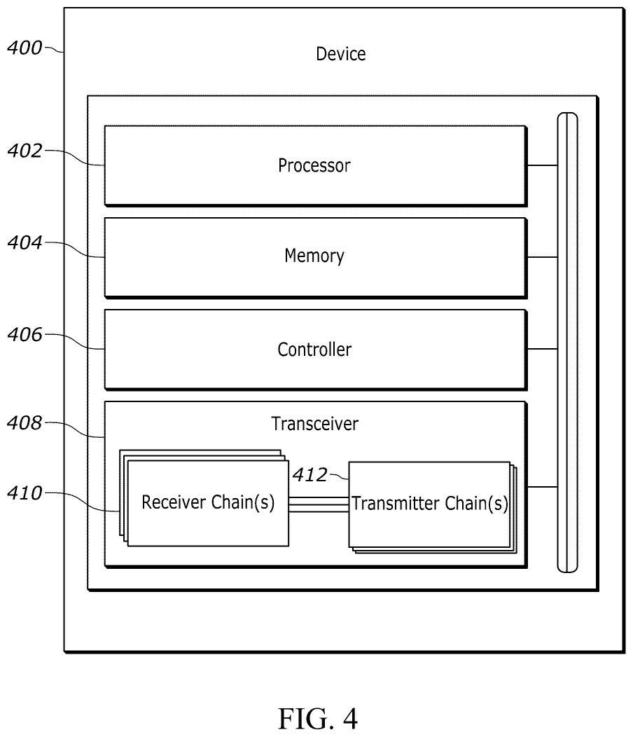

FIG. 4 illustrates an example of a UE 400, in accordance with aspects of the present disclosure. The UE 400 may include at least one processor 402, at least one memory 404, at least one controller 406, and at least one transceiver 408. The processor 402, the memory 404, the controller 406, the transceiver 408, various combinations thereof, or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a central processing unit (CPU), an ASIC, a field programmable gate array (FPGA), or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 to cause the UE 400 to perform various functions described herein. The code may be stored in a non-transitory computer-readable medium such the memory 404 or another type of memory. Computer-readable media includes both non-transitory computer storage media and communication media including any medium that facilitates the transfer of a computer program from one place to another. A non-transitory storage medium may be any available medium that may be accessed by a general-purpose or special-purpose computer.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may also represent and/or include one or more other wireless and/or wired communication interfaces, such as a network interface, a universal serial bus (USB) port, on optical transceiver, and/or any other transceiver, interface, port, communication interface, etc. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive the signal over the air or wireless medium. The receiver chain 410 may include at least one amplifier (e.g., a Low-Noise Amplifier (LNA)) configured to amplify the received signal. The receiver chain 410 may include at least one demodulator configured to demodulate the received signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more modulation techniques such as Amplitude Modulation (AM), Frequency Modulation (FM), digital modulation schemes like Phase-Shift Keying (PSK) or Quadrature Amplitude Modulation (QAM), and/or any other modulation techniques. The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with the examples as disclosed herein.

The UE 400 may be configured to support the establishment of a direct communication connection to a network via an access point of a network of a different type including the performance of an authentication procedure with the network, via the access point of the network of the different type. The authentication procedure can include sending a registration request message to the network via the access point of the network of the different type, which indicates support for non-integrated non-network access, and receiving a request response from the network, which includes an address of a network entity with which the UE establishes a direct communication connection within the network. The UE 400 may be further configured to communicate with the network entity via the established direct communication connection using the received address.

According to a possible embodiment, the performance of the authentication procedure can further include the derivation of an encryption key for use as part of the communications via the direct communication connection to the network in each of the UE and the network. In some instances, the direct communication connection can include an Internet Protocol (IP) communication connection between the UE and the cellular network, which is protected utilizing an encryption key. In some of these instances, the direct communication connection can be between the UE and a user plane function (UPF) of the cellular network.

According to a further possible embodiment, the access point of the network of the different type can be an untrusted access point.

According to a still further possible embodiment, the access point of the network of the different type can be a trusted access point.

According to yet a still further possible embodiment, the network can be a cellular network and the access point of the network of the different type can be part of a WIFI network.

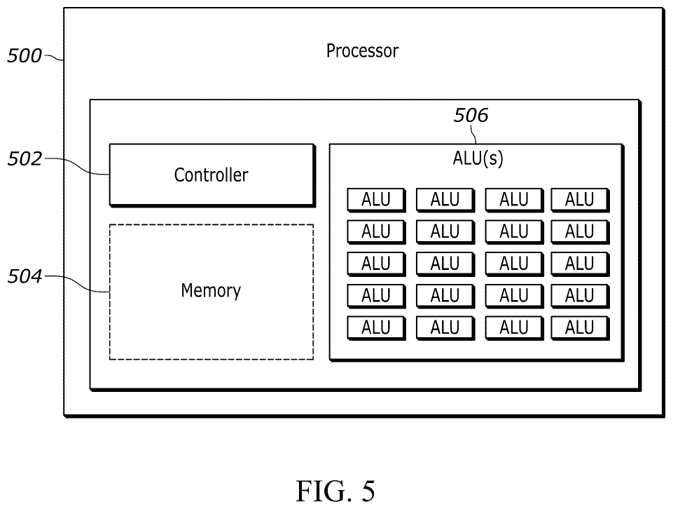

FIG. 5 illustrates an example of a processor 500 in accordance with aspects of the present disclosure. The processor 500 may be an example of a processor configured to perform various operations in accordance with the examples described herein. The processor 500 may include at least one controller 502 configured to perform various operations in accordance with the examples described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500)) or other memory (e.g., Random Access Memory (RAM), Read-Only Memory (ROM), Dynamic RAM (DRAM), Synchronous DRAM (SDRAM), Static RAM (SRAM), Ferroelectric RAM (FeRAM), Magnetic RAM (MRAM), Resistive RAM (RRAM), flash memory, Phase Change Memory (PCM), and others).

The controller 502 may be configured to manage and coordinate various operations (e.g., signaling, receiving, obtaining, retrieving, transmitting, outputting, forwarding, storing, determining, identifying, accessing, writing, and reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating the timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage the flow of data within the processor 500. The controller 502 may be configured to control the transfer of data between registers, ALUs, and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. According to a possible embodiment relating to a UE, the at least one controller 502 can be configured to cause the processor 500 to support the establishment of a direct communication connection to a network via an access point of a network of a different type including the performance of an authentication procedure with the network, via the access point of the network of the different type. The authentication procedure can include sending a registration request message to the network via the access point of the network of the different type, which indicates support for non-integrated non-network access, and receiving a request response from the network, which includes an address of a network entity with which the processor 500 establishes a direct communication connection within the network. The processor 500 may be further configured to communicate with the network entity via the established direct communication connection using the received address.

According to a possible embodiment, the performance of the authentication procedure can further include the derivation of an encryption key for use as part of the communications via the direct communication connection to the network in each of the processor and the network. In some instances, the direct communication connection can include an Internet Protocol (IP) communication connection between the processor and the cellular network, which is protected utilizing an encryption key. In some of these instances, the direct communication connection can be between the processor and a user plane function (UPF) of the cellular network.

According to a further possible embodiment, the access point of the network of the different type can be an untrusted access point.

According to a still further possible embodiment, the access point of the network of the different type can be a trusted access point.

According to yet a still further possible embodiment, the network can be a cellular network and the access point of the network of the different type can be part of a WIFI network.

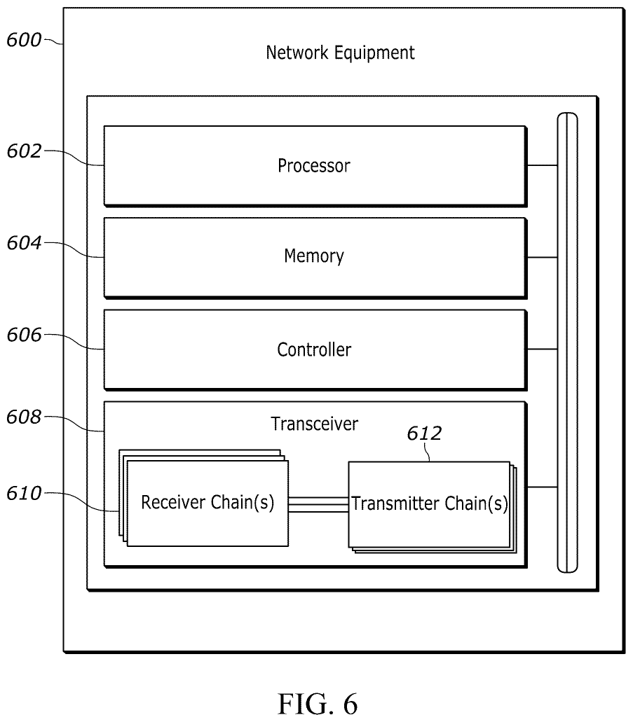

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates the transfer of a computer program from one place to another. A non-transitory storage medium may be any available medium that may be accessed by a general-purpose or special-purpose computer.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent at least one wireless transceiver and may include other transceivers, such as a wired transceiver, like a network interface. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., an LNA) configured to amplify the received signal. The receiver chain 610 may include at least one demodulator configured to demodulate the received signal and obtain the transmitted data by reversing the modulation technique applied during the transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more modulation techniques such as AM, FM, or digital modulation schemes like PSK or QAM, and/or any other modulation techniques. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein.

In operation according to a possible embodiment, the at least one processor 602 can be configured to support a means for establishing a direct communication connection to a user equipment (UE) via an access point of a network of a different type including the performance of an authentication procedure with the UE, via the access point of the network of the different type. The authentication procedure can include receiving a registration request message from the UE via the access point of the network of the different type, which indicates support for non-integrated non-network access. The authentication procedure can further include deriving an encryption key for use as part of the communications via the direct communication connection to the network in each of the UE and the network, and selecting an address of a selected network entity with which the UE can establish the direct communication connection within the network. The authentication procedure can include still further include sending a message to the selected network entity, which includes the encryption key, and sending a request response to the UE, which includes the address of the selected network entity with which the UE establishes a direct communication connection within the network.

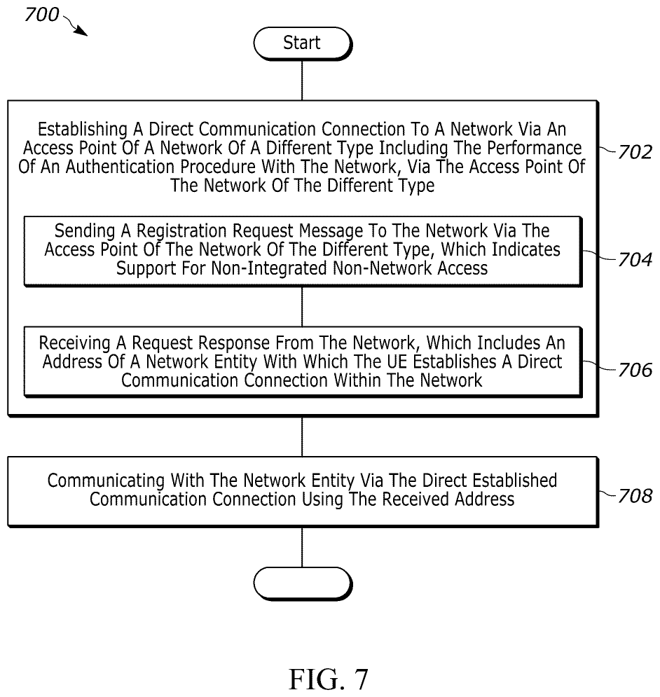

FIG. 7 illustrates an example flowchart 700 of a method in accordance with aspects of the present disclosure. The operations of the method may be implemented by a UE, as described herein. In some implementations, the UE may execute a set of instructions to control the function elements of the UE to perform the described functions.

At 702, the method can include establishing a direct communication connection to a network via an access point of a network of a different type including the performance of an authentication procedure with the network, via the access point of the network of the different type. The authentication procedure can include sending 704 a registration request message to the network via the access point of the network of the different type, which indicates support for non-integrated non-network access, and receiving 706 a request response from the network, which includes an address of a network entity with which the UE establishes a direct communication connection within the network. The method can further include communicating 708 with the network entity via the direct established communication connection using the received address.

According to a possible embodiment, the performance of the authentication procedure can further include the derivation of an encryption key for use as part of the communications via the direct communication connection to the network in each of the UE and the network. In some instances, the direct communication connection can includes an Internet Protocol (IP) communication connection between the UE and the cellular network, which is protected utilizing an encryption key. In some of these instances, the direct communication connection is between the UE and a user plane function (UPF) of the cellular network.

According to a possible embodiment, the network can be a cellular network and the access point of the network of the different type can be part of a WIFI network.

It should be noted that the method described herein describes a possible implementation, and that the operations and the steps may be rearranged or otherwise modified and that other implementations are possible.

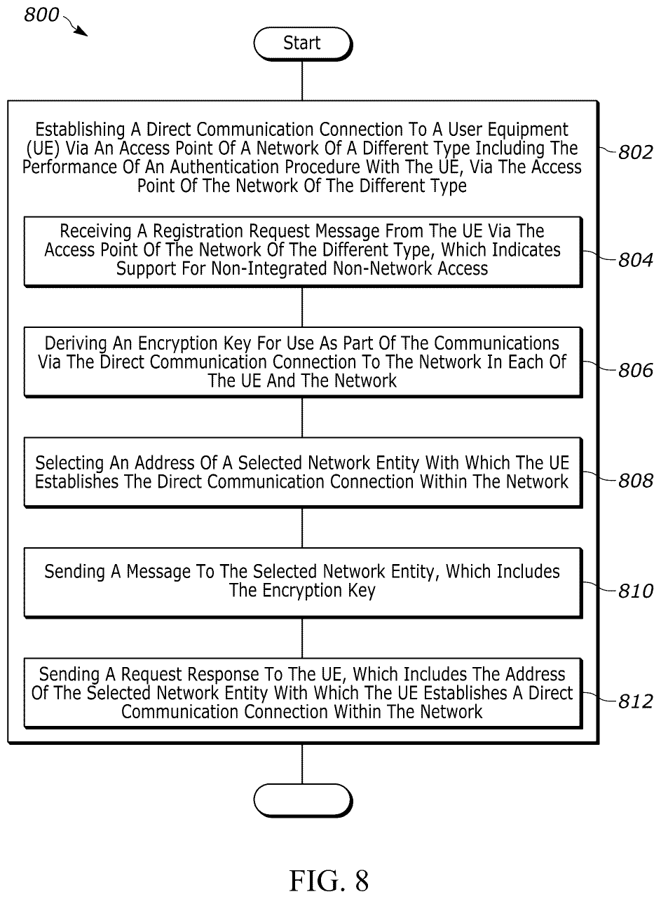

FIG. 8 illustrates an example flowchart 800 of a method in accordance with aspects of the present disclosure. The operations of the method may be implemented by a NE. In some implementations, the NE may execute a set of instructions to control the function elements of the NE to perform the described functions.

At 802, the method can include establishing a direct communication connection to a user equipment (UE) via an access point of a network of a different type including the performance of an authentication procedure with the UE, via the access point of the network of the different type. The authentication procedure can include receiving 804 a registration request message from the UE via the access point of the network of the different type, which indicates support for non-integrated non-network access, deriving 806 an encryption key for use as part of the communications via the direct communication connection to the network in each of the UE and the network, and selecting 808 an address of a selected network entity with which the UE establishes the direct communication connection within the network. The authentication procedure can include sending 810 a message to the selected network entity, which includes the encryption key, and sending 812 a request response to the UE, which includes the address of the selected network entity with which the UE establishes a direct communication connection within the network.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

At least some methods of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

At least some embodiments can improve operation of the disclosed devices. Various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

An article “a” before an element is unrestricted and understood to refer to “at least one” of those elements or “one or more” of those elements. The terms “a,” “at least one,” “one or more,” and “at least one of one or more” may be interchangeable. For example, an element proceeded by “a,” “an,” or the like does not, without more constraints, preclude the existence of additional identical elements in the process, method, article, or apparatus that comprises the element. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). For example, the phrase “at least one of,” “at least one selected from the group of,” or “at least one selected from” followed by a list is defined to mean one, some, or all, but not necessarily all of, the elements in the list. Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, the term “another” is defined as at least a second or more. The terms “including,” “having,” and the like, as used herein, are defined as “comprising.” Terms of approximation, such as “approximately,” “near,” “substantially,” and/or other related terms, unless otherwise defined, are defined as a range within +/−5% of the approximated element, a range within +/−10% of the approximated element, and/or a range close enough to the approximated element to achieve an intended result. All elements of the disclosed embodiments can be modified with such terms. In this document, relational terms such as “first,” “second,” and the like may be used solely to distinguish one entity or action from another entity or action without necessarily requiring or implying any actual such relationship or order between such entities or actions.

The background section is not admitted as prior art, is written as the inventor's own understanding of the context of some embodiments at the time of filing, and includes the inventor's own recognition of any problems with existing technologies and/or problems experienced in the inventor's own work.

What is claimed is:

1. A user equipment (UE) for wireless communication, comprising:
at least one memory; and
at least one processor coupled with the at least one memory and configured to cause the device to:
establish a direct communication connection to a network via an access point of a network of a different type including the performance of an authentication procedure with the network, via the access point of the network of the different type, wherein the authentication procedure includes sending a registration request message to the network via the access point of the network of the different type, which indicates support for non-integrated non-network access, and receiving a request response from the network, which includes an address of a network entity with which the UE establishes a direct communication connection within the network; and
communicate with the network entity via the established direct communication connection using the received address.

2. The UE of claim 1, wherein the performance of the authentication procedure further includes the derivation of an encryption key for use as part of the communications via the direct communication connection to the network in each of the UE and the network.

3. The UE of claim 2, wherein the direct communication connection includes an Internet Protocol (IP) communication connection between the UE and the cellular network, which is protected utilizing an encryption key.

4. The UE of claim 3, wherein the direct communication connection is between the UE and a user plane function (UPF) of the cellular network.

5. The UE of claim 1 wherein the access point of the network of the different type is an untrusted access point.

6. The UE of claim 1 wherein the access point of the network of the different type is a trusted access point.

7. The UE of claim 1, wherein the network is a cellular network and the access point of the network of the different type is part of a WIFI network.

8. A processor for wireless communication, comprising:
at least one controller coupled with at least one memory and configured to cause the processor to:
establish a direct communication connection to a network via an access point of a network of a different type including the performance of an authentication procedure with the network, via the access point of the network of the different type, wherein the authentication procedure includes sending a registration request message to the network via the access point of the network of the different type, which indicates support for non-integrated non-network access, and receiving a request response from the network, which includes an address of a network entity with which the processor establishes a direct communication connection within the network; and
communicate with the network entity via the established direct communication connection using the received address.

9. The processor of claim 1, wherein the performance of the authentication procedure further includes the derivation of an encryption key for use as part of the communications via the direct communication connection to the network in each of the processor and the network.

10. The processor of claim 9, wherein the direct communication connection includes an Internet Protocol (IP) communication connection between the processor and the cellular network, which is protected utilizing an encryption key.

11. The processor of claim 10, wherein the direct communication connection is between the processor and a user plane function (UPF) of the cellular network.

12. The processor of claim 1 wherein the access point of the network of the different type is an untrusted access point.

13. The processor of claim 1 wherein the access point of the network of the different type is a trusted access point.

14. The processor of claim 1, wherein the network is a cellular network and the access point of the network of the different type is part of a WIFI network.

15. A method performed by a user equipment, the method comprising:
establishing a direct communication connection to a network via an access point of a network of a different type including the performance of an authentication procedure with the network, via the access point of the network of the different type, wherein the authentication procedure includes sending a registration request message to the network via the access point of the network of the different type, which indicates support for non-integrated non-network access, and receiving a request response from the network, which includes an address of a network entity with which the UE establishes a direct communication connection within the network; and
communicating with the network entity via the direct established communication connection using the received address.

16. The method of claim 15, wherein the performance of the authentication procedure further includes the derivation of an encryption key for use as part of the communications via the direct communication connection to the network in each of the UE and the network.

17. The method of claim 16, wherein the direct communication connection includes an Internet Protocol (IP) communication connection between the UE and the cellular network, which is protected utilizing an encryption key.

18. The method of claim 17, wherein the direct communication connection is between the UE and a user plane function (UPF) of the cellular network.

19. The method of claim 15, wherein the network is a cellular network and the access point of the network of the different type is part of a WIFI network.

20. A network entity (NE) for wireless communication, comprising:
at least one memory; and
at least one processor coupled with the at least one memory and configured to cause the device to:
establish a direct communication connection to a user equipment (UE) via an access point of a network of a different type including the performance of an authentication procedure with the UE, via the access point of the network of the different type, wherein the authentication procedure includes receiving a registration request message from the UE via the access point of the network of the different type, which indicates support for non-integrated non-network access, deriving an encryption key for use as part of the communications via the direct communication connection to the network in each of the UE and the network, selecting an address of a selected network entity with which the UE establishes the direct communication connection within the network, sending a message to the selected network entity, which includes the encryption key, and sending a request response to the UE, which includes the address of the selected network entity with which the UE establishes a direct communication connection within the network.
